(19) United States
(12) Patent Application Publication
(10) Pub. No.: US 2008/0261634 A1
(43) Pub. Date: Oct. 23, 2008

(54) Dynamic Display Generation for Mobile Communication Devices

(75) Inventors: Rodrigo Bahia De Cerqueira Viana, Rio de Janeiro (BR); Helder Ribeiro Dos Santos, Niteroi (BR); Stefano Melucci, Rio de Janeiro (BR)

Correspondence Address: FISH & RICHARDSON PC, P.O. BOX 1022, MINNEAPOLIS, MN, 55440-1022, US

(73) Assignee: Blah! Sociedade Anonima de Servicos e Comercio

(21) Appl. No.: 11/942,686

(22) Filed: Nov. 19, 2007

Related U.S. Application Data
(63) Continuation of application No. 10/991,126, filed on Nov. 17, 2004, now abandoned.
(60) Provisional application No. 60/525,560, filed on Nov. 26, 2003.

(51) Int. Cl. H04Q 7/20

(52) U.S. Cl. 455/466

(57) ABSTRACT

A method and apparatus, including a computer program product, implementing techniques for receiving, from a dynamic application server, a short message including a dynamic menu encoded using one of a plurality of protocols supported by a mobile communications device, interpreting the encoded dynamic menu, and rendering a dynamic menu on the screen of the mobile communications device based on the interpreted encoded dynamic menu.

### CLAIM OF PRIORITY

This application is a continuation of U.S. Utility patent application Ser. No. 10/991,126 filed Nov. 17, 2004, the entire contents of which are hereby incorporated by reference.

### BACKGROUND

The present invention relates to mobile communications, and more particularly to execution of interactive applications using mobile communication devices GSM (Global System for Mobile Communication) equipment manufacturers and carriers adhere to a set of international standards, which cover aspects of mobile communication from the physical size and characteristics of certain devices to the way they handle and store incoming information.

GSM-based mobile telephones support both digitized voice communications between mobile telephones and the fixed communication infrastructure as well as data communications. Data communication is supported by a Short Message Service (SMS), and in certain areas additionally by connection-based services such as General Packet Radio Service (GPRS). SMS provides a way of sending short messages from mobile telephones or computers to mobile telephones and receiving short messages from mobile telephones. A message received at a mobile telephone can consist of text characters to read by a person, or data to be handled by a computer program executing in the mobile telephone.

GSM telephones include a removable electronic module, a Subscriber Identity Module (SIM), that includes information related to a subscriber. The GSM standards define the physical, electrical, and software interfaces for SIM modules. A SIM is a smart card that provides a secure, tamper-resistant environment for the cryptographic keys that GSM carriers use to authenticate individual subscribers to the network connection and track those subscriber's activities once they are on the air. The SIM maintains a constant connection to the network as long as the mobile device remains on. This location-aware, authenticated connection is what allows subscribers to roam from network to network around the world. Although SIMs are generally associated with GSM phones, SIMs or functionally similar modules can also be found in CDMA phones, iDen phones, and TDMA phones.

GSM SIMs can also include a processor and memory that allow hosting of software applications on the SIM. The SIM Application Toolkit (SAT) standardizes the way in which such applications can be developed for and loaded onto the SIM by SIM application developers. The SAT API (application program interface) provides for two types of information flow between a SIM Toolkit application and the user device or the network, namely proactive commands and event downloads. An event download is a message from the user device to a SIM Toolkit application notifying it of an event, such as an incoming voice call or SMS message. A proactive command is a command from a SIM Toolkit application to the user device asking it to do something on its behalf. As of the GSM standards in September 2003, there are 31 proactive commands on the SAT API as listed in ETSI TS 102.223. These 31 proactive commands can be divided into four categories: (1) application commands that SIM Toolkit applications use to interact with a user of the device (e.g., Display Text, Get Input, Setup Menu); (2) smart-card commands that the SIM uses to interact with another smart card plugged into the user device (e.g., Power On Card, Launch Browser); (3) general communication commands that the SIM uses to interface with various bearers (e.g., GSM, GPRS) that the user device supports (e.g., Get Data, Receive Data, Open Channel); and (4) system commands that the SIM uses to stay synchronized with the user device and the network (e.g., Poll Interval, Language Notification).

One type of application that has been developed for mobile telephones has been a “microbrowser” application that enables a mobile user to access remote content in a manner similar to computer users accessing Web pages. SIM-hosted microbrowsers have been developed to operate virtually identical to a Web browser. For example, a microbrowser communicates with a network component called Wireless Internet Gateway (WIG), which can access Internet-based servers. The WIG enables the usage of an easy to use application language (e.g., Wireless Markup Language (WML)). WML applications are stored on a content provider's server on the network. When a user selects an item in a service menu displayed on the user device, the microbrowser sends a SMS message including a Uniform Resource Locator (URL) to the WIG. The WIG uses HyperText Transfer Protocol (HTTP) to retrieve WML data associated with the URL, translates the WML content into bytecodes, and sends the bytecodes back to the microbrowser in an SMS message. The microbrowser executes the byte-coded program and renders one or more menus on the display of the user device.

### SUMMARY

In general, in one aspect, the invention provides a method and apparatus, including a computer program product, implementing techniques for displaying a menu of an application on a screen of a mobile communications device. The application has at least one static menu encoded in a memory of the mobile communications device and at least one dynamic menu encoded in a memory of a dynamic application server. The computer program product at the mobile communications device includes techniques for displaying, on the screen of the mobile communications device, a menu of an application having one or more menu items, receiving a user input selecting a menu item, determining whether the user-selected menu item is associated with a static menu, and if so, retrieving the static menu from the memory of the mobile communications device, and displaying the static menu on the screen of the mobile communications device. If the user-selected menu is not associated with a static menu, a short message including a dynamic display request is generated and sent to the dynamic application server. The computer program product at the dynamic application server includes techniques for generating a short message based on the dynamic display request, and sending the generated short message to the mobile communications device. The generated short message can include dynamic display content encoded using one of a plurality of protocols supported by the mobile communications device. The computer program product at the mobile communications device can also include techniques for receiving, from the dynamic application server, a short message including a dynamic display encoded using one of a plurality of protocols supported by the mobile communications device, interpreting the encoded dynamic display, and rendering a dynamic display on the screen of the mobile communications device based on the interpreted encoded dynamic menu. The dynamic display rendered on the screen of the mobile communications device can be a dynamic menu, a dynamic text display, or a dynamic text display requesting user input.

The invention can be implemented to realize one or more of the following advantages. The Dynamic Interpreter has a small memory footprint on the SIM of approximately 3.06 Kb. The Dynamic STK messages are secured by digital signatures generated by the dynamic application server. The dynamic application server creates the Dynamic STK messages which are sent to the user devices without needing to pass through or be processed by a separate gateway (e.g., a WIG).

One implementation includes all of the foregoing advantages.

The details of one or more embodiments of the invention are set forth in the accompanying drawings and the description below. Other features, aspects and advantages of the invention will become apparent from the description, the drawings, and the claims.

### BRIEF DESCRIPTION OF THE DRAWINGS

FIG. 1 shows a communication system.

FIG. 2 shows a timing diagram.

FIG. 3 shows a short message encoded using the Dynamic STK communication protocol.

Like reference numbers and designations in the various drawings indicate like elements.

### DETAILED DESCRIPTION

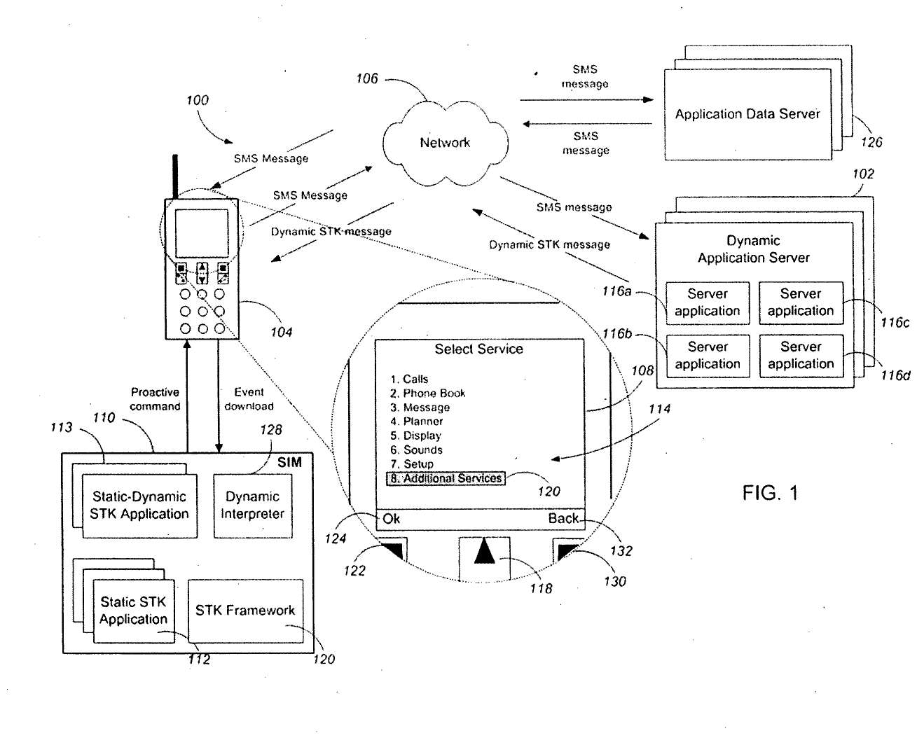

FIG. 1 shows a communications system 100 that supports communication between user devices 104 (e.g., mobile telephones) and other user devices (e.g., other telephones) and server computers (102 or 126). The system supports transmission of short messages between application data server 126 or dynamic application server 102 and a user device 104 through a network 106. For ease of description, the term “SMS message” refers to a short message encoded using the ETSI TS 123.040 SMS protocol; the term “Dynamic STK message” refers to a short message encoded using a Dynamic STK communication protocol. The dynamic application server 102 may be configured to send bytecode commands in one or more Dynamic STK messages to the user device 104, which uses the received bytecode commands to render a menu on the screen 108, or to perform other functions to provide information to or solicit information from the user of the device 104.

In the description of the examples to follow, the user device 104 is a GSM phone having a SIM 110. In an alternative version of the system 100, the user device 104 may be a CDMA phone having a R-UIM, TDMA phone having a TIM, or the like. The illustrated communications system 100 may include additional or alternative user devices that are not shown, or the communications system 100 may include only a subset of the user devices that are shown.

The SIM 110 has memory (for data and applications), a processor and the ability to interact with the user. Current SIMs typically have 16 to 64 kb of memory, which can be used to store a SIM Toolkit framework 120, one or more SIM Toolkit application code and their associated data (112 and 113), as well as the secret keys and certificates used for digital signatures and other encryption and authentication functions (not shown). The SIM Toolkit (STK) framework 120 is the GSM Java Card runtime environment that is defined by ETSI TS 101.476 V8.5.0 (2002-09). The STK applications (112 and 113) may be implemented as text-based, menu-driven, single-key response STK applications (112 and 113). The term “text-based, menu-driven, single-key response STK application” generally refers to an application that provides a user interface in which a user can highlight a command or option from the menu provided on a screen 108 of the user device 104 and then press a single key to select the command or option.

In addition to the STK applications (112 and 113), the SIM 110 also has an application called the Dynamic Interpreter 128. The Dynamic Interpreter 128 is configured to communicate with the dynamic application server 102 and to generate dynamic menus, alerts and text boxes, for example, when Dynamic STK messages are received on the user device 104. In one implementation, the Dynamic Interpreter 128 is a Java card applet deployed on the SIM 110 having an overall size that occupies approximately 3.06 Kb of memory space on the SIM 110. The Dynamic Interpreter 128 translates bytecode commands provided in the Dynamic STK messages into SIM proactive commands and instructs the STK framework 120 to execute the SIM proactive commands. In doing so, the Dynamic Interpreter 128 extends the functionality of a STK application (112 or 113) by enabling a mobile network operator to add dynamic menus to a STK application (112 or 113) on the user device 104. As a result, an application developer is able to optimize the performance of a STK application (112 or 113) by splitting the storage of data used to render a menu on the user device 104 between the SIM 110 and the dynamic application server 102 on the network 106.

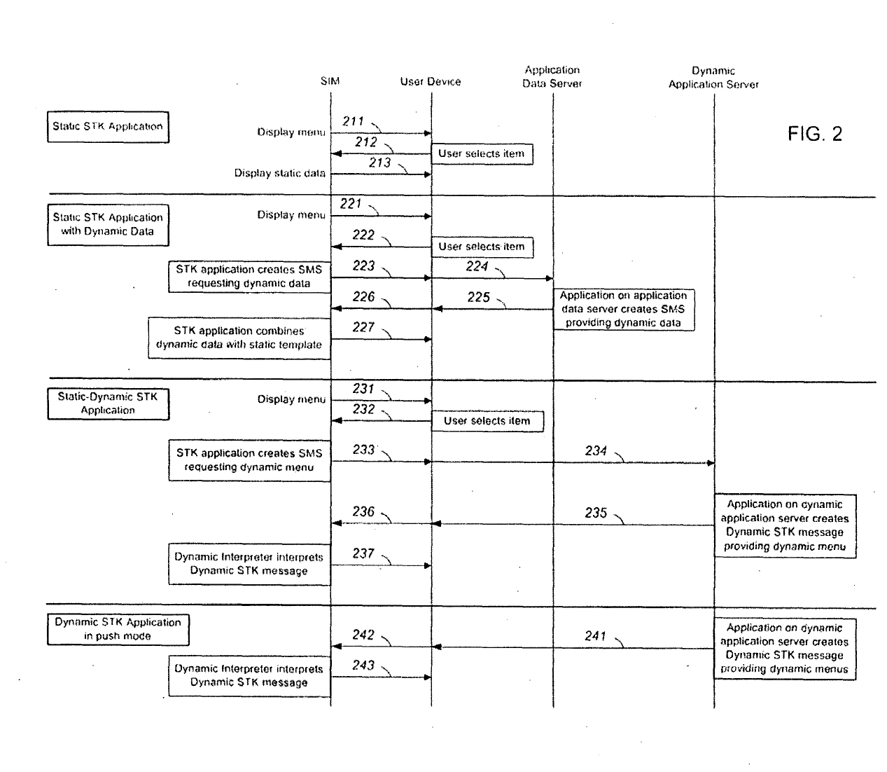

An example of a static STK application 112 is a phone directory stored in the SIM 110. Referring to FIG. 2, the static STK application 112 sends a STK “Select Item” proactive command 211 which causes the user device 104 to render a menu of a phone directory on the screen 108 of the user device 104. When the user selects an item (i.e., an entry in the phone directory), the user device 104 sends a STK “User Activity Event” event download 212 to the static STK application 112 and the static STK application 112 executes an action associated with the user-selected item resulting in a retrieval of data from a memory of the SIM 110 (i.e., retrieval of static data). If the phone directory menu has a flat structure, the static STK application 112 sends a STK “Display Text” proactive command 213 which causes the user device 104 to display one or more lines of text on the screen 108. If the phone directory menu is part of a hierarchical menu structure, the static STK application 112 will send a STK “Select Item” proactive command 213 that will result in a rendering of a sub-menu having a list of options or commands that a user can select to execute.

A static STK application 112 may also access a remote application data server 126 for presentation of data on the screen 108 of the user device 104. Such a static STK application 112 generally has a static template and dynamic data, and the static template is stored in the part of the SIM 110 associated with the static STK application 112. For example, referring to FIG. 2, such a static STK application 112 sends a proactive command 221 which causes the user device 104 to provide a menu that presents a list of options or commands to the user from which a user makes a selection. When the user selects an item (i.e., an entry in the phone directory), the user device 104 sends an event download 222 to the static STK application 112 and the static STK application 112 executes the action associated with the user-selected option or command. The static STK application 112 sends a proactive command 223 which causes the user device 104 to send a request in an SMS message 224 to an application data server 126 on the network 106 requesting data. The application data server 126 processes the SMS message and returns transaction-specific dynamic data 225 that arrives at the user device as a SMS message addressed to the STK application 112 that sent the request. The user device 104 receives the SMS message and passes the data to the static STK application 112 using an event download 226. The static STK application 112 combines the received dynamic data with the static template and sends a proactive command 227 which causes the user device 104 to display the result to the user on the screen 108 of the user device 104.

Such static STK applications 112 may be developed by a mobile network operator or vendor using the SIM Application Toolkit (described above) and provided to the user as value-added services. For example, the security that the SIM 110 provides lends itself to secure applications such as mobile banking and mobile commerce. The encryption used on the SIM 110 ensures that only the relevant bank can read the information that has been sent via the network 108 and can only be decrypted once it has reached this secure source. The static STK application 112 can also be used to provide mobile phone users with location based information services—i.e., the information that the user will receive will be dependent on where they are at any given time. For example, the static STK application 112 can be used to request information on Boston-based restaurants when the user device is identified by the network to physically be in Boston. These exemplary static STK applications 112 may be burned into the SIM 110 prior to its distribution in the market, or downloaded onto the SIM 110 over the network 108 once it is deployed in the market.

The SIM 110 also has a number of static-dynamic STK applications 113 stored in its memory. In a static-dynamic STK application 113, portions of the interaction with a user (i.e., information to be displayed and solicited, as well as the flow of the application) are encoded in the software stored in the SIM 110, while other portions are encoded in software (e.g., server application 116) hosted in the dynamic application server 102. Say, for example, a mobile network operator loads a static-dynamic STK application 113 on the SIM 110 for user devices 104 on its network 108. The static-dynamic STK application 113 is a text-based, menu-driven, single-key response application that is stored in the user device's SIM 110. Referring to FIG. 2, the static-dynamic STK application 113 may send a proactive command 231 which causes the user device 104 to display a predetermined menu 114 of services consisting of some or all of the following: “Calls”, “Phone Book”, “Message”, “Planner”, “Display”, “Sounds”, “Setup”, and “Additional Services” 120. The user can scroll through the list using the up and down arrows 118 provided on the user device 104, and highlight the item 120 that the user would like to select for execution. When the user clicks on a button 122 on the user device 104 associated with the “ok” label 124, the user device 104 sends an event download 232 to the static-dynamic STK application 113 which causes the application 113 to execute an action associated with the highlighted item 120.

Each item in the displayed menu 114 is associated with an item command. The term “dynamic display request” refers to an item command that is to be sent to a server application 116a-d for processing. Examples of dynamic display requests include a dynamic menu request, a dynamic text display request, and a dynamic text display with user input request, to name a few. When a user selects a menu item that invokes a portion of the application that is encoded on the dynamic application server 102, the software for the static-dynamic STK application 113 on the SIM constructs a SMS message that has a number of standard header elements in addition to the dynamic display request provided in the payload. One of the header elements includes a destination address of the message which denotes the final recipient of the SMS message. In one example, the destination address of the SMS message is a Mobile Subscriber ISDN (MSISDN) associated with the server application 116a on the dynamic application server 102. The static-dynamic STK application 113 passes the constructed SMS message to the user device 104 which then sends it to the dynamic application server 102 using the STK “Send Short Message” proactive command 233.

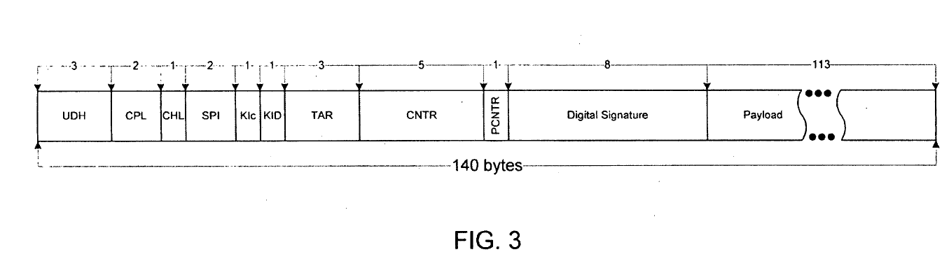

The SMS message 234 is routed to the server application 116a having the destination address provided in the SMS message. The server application 116a receives the SMS message and based on application logic resident at the server application 116a creates a Dynamic STK message 235 to be sent to the user device 104. Generally, each Dynamic STK message includes a header, a digital signature, and a payload, and is encoded using the Dynamic STK communication protocol as shown in FIG. 3. According to the limitations of SMS messages, each Dynamic STK message created by the server application 116 has a maximum length of 140 bytes.

The header is formatted according to the ETSI GSM 03.48 specification in order to generate in the SIM 110 a reception of a SMS-PP Formatted Envelope event. The header provides a “Toolkit Application Reference” (“TAR”) that uniquely identifies an STK application on the SIM 110. By inserting a Dynamic Interpreter identifier in the “Toolkit Application Reference” header field of a Dynamic STK message, the user device 104 will pass the received message to the Dynamic Interpreter 128 (rather than a STK application 112 or 113) for processing. That is, the Dynamic Interpreter 128 does not necessarily know based on the header which static-dynamic STK application 113 was responsible for initiating the dynamic portion of an application.

Each Dynamic STK message created by the server application 116a includes an 8-byte long digital signature. When the Dynamic Interpreter 128 receives a Dynamic STK message, the Dynamic Interpreter 128 authenticates the source of the message by examining the digital signature prior to interpreting the bytecode command specified in the payload of the received Dynamic STK message. In the event of an invalid digital signature (e.g., a non-authorized application created and sent the Dynamic STK message), the Dynamic Interpreter 128 discards the received Dynamic STK message. In one implementation, the server application 116a uses the DES (Digital Encryption Standard) CBC (Cipher Blocking Chaining) algorithm to create a digital signature that is appended to a Dynamic STK message that is sent to the user device 104. The DES-CBC algorithm is a symmetric secret-key block algorithm. It has a block size of 64 bits and requires an explicit Initialization Vector (IV) of 8 octets (64 bits). This IV immediately precedes the protected (encrypted) payload. The IV must be a random value. In one implementation, the server application 116 uses random data for the first IV and the last 8 octets of encrypted data from an encryption process as the IV for the next encryption process.

The server application 116a uses the payload area of the Dynamic STK message to send dynamic display content to the Dynamic Interpreter 128. According to the limited size of SMS messages and the Dynamic STK message header, the payload area has a maximum length of 113 bytes. If the dynamic display content to be sent to the Dynamic Interpreter 128 is longer than 113 bytes, the server application 116 is implemented to send the dynamic display content in multiple Dynamic STK messages. In one implementation, the server application 116a includes (or has access to) a class library having a number of classes (e.g., a “Select Item” class, a “Display Text” class, and a “Get Info” class) which is used to construct the dynamic display content. Upon receipt of the SMS message, the server application 116a interprets the dynamic display request in the payload of the SMS message and constructs dynamic display content that is to be rendered on the screen 108 of the user device 104. In one example, the server application 116a uses data provided in the SMS message payload to instantiate the “Select Item” class of the library. The server application 116a then encodes the “Select Item” dynamic display content as a two-dimensional byte array (“dynamic display generation command”) in TLV (Tag-Length-Value) format. Appendix I shows one example of the “Select Item” dynamic display generation command structure. The server application 116a sends the Dynamic STK message with the dynamic display generation command as its payload to the user device 104.

Upon receipt and authentication of the Dynamic STK message 236, the Dynamic Interpreter 128 translates the dynamic display generation command into an STK proactive command. If necessary, the Dynamic Interpreter 128 may buffer the Dynamic STK messages until the required number of Dynamic STK messages are received. For example, if the server application 116a constructed “Select Item” dynamic display content that had to be split into three Dynamic STK messages because of the payload size limitation of SMS messages, the Dynamic Interpreter 128 is configured to wait until all three dynamic display generation commands are received before translating the dynamic display generation commands into the STK “Select Item” proactive command. Once translated, the Dynamic Interpreter 128 instructs the STK framework 120 to execute the STK “Select Item” proactive command 237, which results in the rendering of a dynamic menu on the screen 108 of the user device 104.

The dynamic menu rendered on the screen 108 includes a list of menu items. The user can scroll through the list using the up and down arrows 118 provided on the user device 104, and highlight the item that the user would like to select for execution. When the user clicks on a button 122 on the user device 104 associated with the “ok” label 124, the user device 104 sends an event download 232 to the Dynamic Interpreter 128 which causes the Dynamic Interpreter 128 to execute an action (specified in the payload of the Dynamic STK message 236 received from the server application 116a) associated with the highlighted item 120. Referring to the “Select Item” bytecoded content structure of Appendix I, each item in the displayed dynamic menu is associated with an item command encoded in the Dynamic STK message from the server application 116a. In one implementation, the structure of the “item command” field is “<number><content>”, where “number” refers to a valid MSISN associated with an server application 116a-d on the dynamic application server 102, and “content” refers to a dynamic display request that is to be sent to the server application 116a-d as payload. In this manner, each item in the displayed dynamic menu can be associated with a different server application 116a-d and a different payload. Once the user has made an item selection, the Dynamic Interpreter 128 constructs a SMS message having (as its payload) the dynamic display request associated with the selected item. The Dynamic Interpreter 128 then sends the constructed SMS message to the server application 116a-d having the number associated with the selected item, where it is processed as described above.

Referring to FIG. 2, in addition to creating Dynamic STK messages in response to a user request via an SMS message, the server application 116 residing on the dynamic application server 102 may also operate in a push mode. In such a mode, the server application 116 monitors a data store of events, such as news, weather, stock prices or other selected information. When the server application 116 detects a change in the data store of events, the server application 116 creates and sends a Dynamic STK message 241 to user devices 104 on the network that are associated with the data store in order to provide an updating of the events on the user device 104. Generally, such Dynamic STK messages are sent independent of any action taken by a user of the user device 104. This ensures that the data stored or displayed on the user device 104 will be relatively current and correct in relation to the monitored data in the data store. The user device 104 passes such a Dynamic STK message 242 to the Dynamic Interpreter 128, which interprets the received Dynamic STK message and instructs the STK framework to execute the appropriate STK proactive command 243.

Other versions of the system 100 can make use of alternatives listed below. The SIM 110 may have software for a number of text-based, menu-driven, voice recognition SIM applications 112 stored in its memory. The processor may be external to the SIM 110. The SIM 110 may be affixed permanently to the user device 104 (i.e., not removable). Other encryption/authentication approaches may be utilized in order to secure the data in the Dynamic STK message. The Dynamic STK protocol may allow for a different maximum message length (i.e., other than 140 bytes). The communication between the user device 104 and the computer servers (102 and 126) may be accomplished using protocols (e.g., GPRS, CSD) other than the SMS protocol. The server application 116 may include (or have access to) a database of content (e.g., ringtones, logos and games). The server application 116 can interpret an SMS message payload request and execute a “ringtone delivery” action specified by the application business logic. The server application 116 may include application logic for building static-dynamic STK applications 113 that provide value-added services, such as games, chat, quizzes, prepaid recharge, banking, and mobile commerce to the user.

The Dynamic Interpreter 128 may support additional or different STK proactive commands. For example, to determine the International Mobile Equipment Identity (IMEI) of each user device 104 on the network 106, the server application 116 operating in a push-mode constructs a Dynamic STK message having a “Provide Local Info” dynamic display content. The server application 116 then encodes the “Provide Local Info” dynamic display content as a dynamic display generation command in TLV format and sends the Dynamic STK message with the bytecoded command as its payload to the user devices 104.

Upon receipt and authentication of the Dynamic STK message, the Dynamic Interpreter 128 in each user device 104 translates the dynamic display generation command into the STK “Provide Local Info” proactive command. Once translated, the Dynamic Interpreter 128 instructs the STK framework 120 to execute the STK “Provide Local Info” proactive command, which results in the transmission of a SMS message providing the IMEI of the user device 104 to one or more server applications 116a-d. Each IMEI can then be used by the server applications 116a-d to customize the content so that the content delivered by the server applications 116 are compatible with the associated user device 104.

The communications system 100 may include a mobile communications network or a satellite communications network. The communications system 100 may use a cellular tower of a mobile network operator to communicate analog or digital signals between two or more remotely located devices. Other versions of the communications system 100 may use any technology, or combination of technologies, for transmitting signals. These technologies include, for example, Advanced Cellular telephone System (AMPS), Narrowband Advanced Cellular telephone Service (NAMPS), Frequency Shift Keying (FSK), Frequency Division Multiple Access (FDMA), Time Division Multiple Access (TDMA), and Code Division Multiple Access (CDMA), or any standard, such as Global System for Mobile communications (GSM) or Cellular Digital Packet Data (CDPD).

A variety of user devices that communicate using the communications system 100, such as a mobile telephone 104, a pager, a personal digital assistants (“PDA”), and a portable personal communicator (such as a mobile communicator), or other two-way messaging devices that are capable of communicating a variety of content including text messages can make use of the approaches described above. The communications system 100 may use a satellite to enable communications between two or more remotely located devices. The satellite may communicate directly with a device, such as a satellite telephone, through a signal, or the satellite may communicate indirectly with a particular mobile communications device, such as the mobile telephone 104, the pager, the PDA, or the portable personal communicator, by communicating signals to a ground station that communicates with the mobile communications devices through another communications network, such as a cellular tower. Some mobile devices, such as the mobile telephone 104 or the PDA, may be able to receive wireless communications from a cellular tower or a satellite.

The communications system 100 may use a communications pathway to connect with the Public Switched Telephone Network (PSTN). The PSTN is a telephone system that is capable of connecting a variety of devices, such as telephones, fax machines, or answering machines (none of which are shown), through a communications system that directs calls to a particular location, generally using land lines.

The server computers (102 and 126) include a variety of input/output (I/O) devices (e.g., mouse, keyboard, and display). Each server computer has a CPU, an I/O unit, a memory, and a data storage device. Data storage device may store machine-executable instructions, data, and various programs, such as an operating system and one or more application programs, for implementing a process for creating short messages, all of which may be processed by the CPU. Each computer program may be implemented in a high-level procedural or object-oriented programming language, or in assembly or machine language if desired; and, in any case, the language may be a compiled or interpreted language. The data storage device may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; and Compact Disc Read-Only Memory (CD-ROM).

Each of the server computers (102 and 126) may include a communications card or device (e.g., a modem and/or a network adapter) for exchanging data with the network 106 using a communications link (e.g., a telephone line, a wireless network link, a wired network link, or a cable network). Examples of the network 106 include the Internet, the World Wide Web, WANs, LANs, analog or digital wired and wireless telephone networks (e.g., ISDN (“Integrated Services Digital Network”), and DSL (“Digital Subscriber Line”) including various forms of DSL such as SDSL (“Single-line Digital Subscriber Line”), ADSL (“Asymmetric Digital Subscriber Loop), HDSL (“High bit-rate Digital Subscriber Line”), and VDSL (“Very high bit-rate Digital Subscriber Line)), radio, television, cable, satellite, and/or any other delivery mechanism for carrying data.

Other examples of server computers (102 and 126) may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

The invention has been described in terms of particular embodiments. Other embodiments are within the scope of the claims. For example, the steps of the invention can be performed in a different order and still achieve desirable results.

What is claimed is:

1. A method comprising:
receiving a short message from a mobile communications device including a dynamic display request;
generating a short message based on the dynamic display request, wherein the generated short message includes dynamic display content encoded using one of a plurality of protocols supported by the mobile communications device; and
sending the generated short message to the mobile communications device.

2. The method of claim 1, further comprising:
receiving the generated short message at the mobile communications device;
generating a dynamic display based on the dynamic display content; and
rendering the dynamic display on a screen of the mobile communications device.

3. The method of claim 2, wherein the dynamic display rendered on the screen of the mobile communications device comprises a dynamic menu, a dynamic text display, and a dynamic text display requesting user input.

4. The method of claim 1, wherein generating the short message includes selecting a protocol from the plurality of protocols supported by the mobile communications device.

5. The method of claim 4, wherein selecting the protocol from the plurality of protocols supported by the mobile communications device includes selecting the protocol based on a capability of the mobile communications device to interpret the protocol.

6. The method of claim 1, wherein the plurality of protocols include at least one of Short Message Service (SMS) protocol, Transmission Control Protocol (TCP), User Datagram Protocol (UDP), and Dynamic STK Protocol.

7. The method of claim 1, further comprising:
encoding the dynamic display content using one of the plurality of protocols to generate one or more dynamic display generation commands.

8. The method of claim 7, wherein sending the generated short message to the mobile communications device includes sending each of the one or more dynamic display generation commands to the mobile communications device separately.

9. A method comprising:
monitoring a data store for a change in the data store;
generating a short message upon determining that a change in the data store has occurred, wherein the generated short message includes dynamic display content encoded using one of a plurality of protocols supported by the mobile communications device; and
sending the generated short message to a mobile communications device associated with the data store.

10. The method of claim 9, further comprising:
associating the mobile communications device with the data store prior to generating the short message.

11. The method of claim 10, wherein associating the mobile communications device with the data store includes associating the mobile communications device with the data store using user-input received through a network browser interface.

12. A method comprising:
receiving a user input selecting a menu item displayed on a screen of a mobile communication device;
in response to the user selection, generating a short message including a dynamic display request; and
sending the generated short message to a remote application server.

13. The method of claim 12, wherein the dynamic display request includes a request for one of a dynamic menu, a dynamic text display, and a dynamic text display requesting user input.

14. A method comprising:
receiving, at a mobile communications device, a short message including a dynamic display bytecoded command;
interpreting the dynamic display bytecoded command; and
rendering a dynamic display on a screen of the mobile communications device based on the interpreted dynamic display bytecoded command.

15. A method for displaying a menu of an application on a screen of a mobile communications device, the application having at least one static menu encoded in a memory of the mobile communications device and at least one dynamic menu encoded in a memory of a dynamic application server, the method comprising:
displaying, on the screen of the mobile communications device, a menu of an application having one or more menu items;
receiving a user input selecting a menu item;
determining whether the user-selected menu item is associated with a static menu, and if so, retrieving the static menu from the memory of the mobile communications device, and displaying the static menu on the screen of the mobile communications device, otherwise, generating a short message including a dynamic display request, and sending the generated short message to the dynamic application server;
receiving, from the dynamic application server, a short message including a dynamic display encoded using one of a plurality of protocols supported by the mobile communications device;
interpreting the encoded dynamic display; and
rendering a dynamic display on the screen of the mobile communications device based on the interpreted encoded dynamic menu.

16. A computer program product tangibly embodied on an information carrier, the product comprising instructions operable to cause data processing apparatus to:
receive a short message from a mobile communications device including a dynamic display request;
generate a short message based on the dynamic display request, wherein the generated short message includes dynamic display content encoded using one of a plurality of protocols supported by the mobile communications device; and
send the generated short message to the mobile communications device.

17. The product of claim 16, wherein the instructions to generate the short message comprise instructions to select a protocol from the plurality of protocols supported by the mobile communications device.

18. The product of claim 17, wherein the instructions to select the protocol from the plurality of protocols supported by the mobile communications device comprise instructions to select the protocol based on a capability of the mobile communications device to interpret the protocol.

19. The product of claim 16, further comprising instructions to:
encode the dynamic display content using one of the plurality of protocols to generate one or more dynamic display generation commands.

20. The product of claim 16, wherein the instructions to send the generated short message to the mobile communications device comprise instructions to send each of the one or more dynamic display generation commands to the mobile communications device separately.

21. A computer program product tangibly embodied on an information carrier, the product comprising instructions operable to cause data processing apparatus to:
monitor a data store for a change in the data store;
generate a short message upon determining that a change in the data store has occurred, wherein the generated short message includes dynamic display content encoded using one of a plurality of protocols supported by the mobile communications device; and
send the generated short message to a mobile communications device associated with the data store.

22. The product of claim 21, further comprising instructions to:
associate the mobile communications device with the data store prior to generating the short message.

23. The product of claim 21, wherein the instructions to associate the mobile communications device with the data store comprise instructions to associate the mobile communications device with the data store using user-input received through a network browser interface.

24. A computer program product tangibly embodied on an information carrier, the product comprising instructions operable to cause data processing apparatus to:
receive a user input selecting a menu item displayed on a screen of a mobile communication device;
in response to the user selection, generate a short message including a dynamic display request; and
send the generated short message to a remote application server.

25. The product of claim 24, wherein the dynamic display request includes a request for one of a dynamic menu, a dynamic text display, and a dynamic text display requesting user input.

26. A computer program product tangibly embodied on an information carrier, the product comprising instructions operable to cause data processing apparatus to:
receive, at a mobile communications device, a short message including a dynamic display bytecoded command;
interpret the dynamic display bytecoded command; and
render a dynamic display on a screen of the mobile communications device based on the interpreted dynamic display bytecoded command.

27. A system comprising:
a communications system;
an application server; and
one or more mobile communications devices, each mobile communications device having an application environment includes
an interpreter application for receiving, through the communications system, a short message from the application server, the short message including a dynamic display encoded using one of a plurality of protocols supported by the interpreter application, and interpreting the encoded dynamic display;
a user interface for rendering a dynamic menu on the screen of the mobile communications device based on the interpreted encoded dynamic menu.

28. The system of claim 27, wherein the application environment is a removable SIM card having SIM Toolkit Application code.

29. The system of claim 27, wherein the communications system is a mobile communications network.
